(19) United States
(12) Patent Application Publication
(10) Pub. No.: US 2017/0276606 A1
(43) Pub. Date: Sep. 28, 2017

(54) FLUORESCENCE PHOTOGRAPHY AND CAMERA SYSTEM BASED ON SMART GLASSES DEVICE AND CONTROL METHOD THEREFOR

(71) Applicants: Changhe HOU, Guangzhou, Guangdong (CN); Qinqin REN, Guangzhou, Guangdong (CN)

(72) Inventors: Changhe HOU, Guangzhou, Guangdong (CN); Qinqin REN, Guangzhou, Guangdong (CN)

(21) Appl. No.: 15/512,136

(22) PCT Filed: Jan. 4, 2015
(86) PCT No.: PCT/CN2015/070035

§ 371 Date: Mar. 17, 2017

(30) Foreign Application Priority Data
Dec. 3, 2014 (CN) 201410729926.4

(51) Int. Cl. G01N 21/64; G06F 1/16; H04N 13/04; G02B 27/01; H04N 5/225

(52) U.S. Cl. CPC G01N 21/64; G02B 27/017; H04N 5/225; H04N 13/0429; G06F 1/163

(57) ABSTRACT

A fluorescence photography and camera system includes a smart glasses device, a light source component and a fluorescent component. The smart glasses device includes a camera having no infrared cut-off filter. The light source component includes a light source component power supply module, a light source, and a light source filter wheel that filters a light emitted from the light source, the light source being connected with the smart glasses device, the light source component power supply module supplying power to the light source. The light source filter wheel includes a light source filter aperture, and a light source filter on the light source filter aperture. The fluorescent component includes a fluorescent filter wheel on the smart glasses device. The fluorescent filter wheel includes a fluorescent filter aperture, a fluorescent filter on the fluorescent filter aperture.

### RELATED APPLICATIONS

The present application is a National Phase of International Application Number PCT/CN2015/070035, filed Jan. 4, 2015, and claims the priority of China Application No. 201410729926.4, filed Dec. 3, 2014.

### TECHNICAL FIELD

The present invention relates to the field of fluorescence detection and more specifically, to a fluorescence photography and camera system based on a smart glasses device, and a control method therefor.

### BACKGROUND

Perceptual ways of human body to surrounding environments include visual sense, auditory sense, olfactory sense, tactile sense, etc., in which most of the information is received from the visual sense. As the only optical information receiving organ of the human body, eyes are responsible for receiving optical signals, transforming them into visual information (electrical activity of nerves) and transferring it to the centre, and thus humans are able to see the surrounding environments. However, the eyes are sensitive only to optical signals having wavelengths of about 400 to 800 nm. Optical signals having wavelengths of less than 400 nm and optical signals having wavelengths exceeding 800 nm cannot be perceived by the eyes.

In order to broaden the perceptual range of the eyes, a variety of techniques, such as fluorescence photography that may allow the places where the substances present are all labeled with fluorescence by combining specific fluorescent dyes with specific test substances, followed by recording by a special camera, have been invented.

The above-describe techniques have been widely applied in the actual life. When conducting fluorescence detection using the above-describe techniques, however, tedious imaging process is required, resulting in a low timeliness. Meanwhile, since the procedure of imaging process is conducted afterwards, a skilled person fails to do further operation immediately according to the results of fluorescence detection. For this purpose, a fluorescence photography and camera system with high timeliness and able to online access to detection results is in a great need for the current market.

### SUMMARY OF THE INVENTION

In order to solve the above deficiencies of the prior arts, the present invention provides a fluorescence photography and camera system based on a smart glasses device. This system conducts photographing of fluorescence images using the smart glasses device, and then projects photographed images on a retina of a user. During this procedure, no complicated imaging process is required, and thus the user may real-time acquire the fluorescence images. In the meantime, functions of zoom in and zoom out may be done to the photographed fluorescence images by the smart glasses device, and the users may realize accurate detection and operation of test substances of various volumes.

In order to achieve the above purpose, the technical solutions of the present invention are as follows:

a fluorescence photography and camera system based on a smart glasses device, comprises a smart glasses device, a light source component and a fluorescent component; wherein the smart glasses device comprises a front facing camera having no infrared cut-off filter;

wherein the light source component comprises a light source component power supply module, a light source, and a light source filter wheel that filters a light emitted from the light source, the light source being connected with the smart glasses device, and the light source component power supply module supplying power to the light source; the light source filter wheel is provided with a light source filter aperture, and a light source filter is installed on the light source filter aperture;

the fluorescent component comprises a fluorescent filter wheel, the fluorescent filter wheel being installed on the smart glasses device, the fluorescent filter wheel being provided with a fluorescent filter aperture, and a fluorescent filter being installed on the fluorescent filter aperture;

during operation of the fluorescence photography and camera system, after passing through the light source filter, an exciting light emitted from the light source illuminates upon a test substance and excites the test substance, and a fluorescent light emitted from the excited test substance illuminates upon the front facing camera of the smart glasses device after passing through the fluorescent filter.

In particular, according to different application scenarios, a user may choose the light source filters and fluorescent filters of different wavelengths, and install them on the light source filter aperture and the fluorescent filter aperture respectively.

In the above-described solution, the user wearing the smart glasses device, when the fluorescence photography and camera system is required to be turned on to detect the test substance, firstly he/she is required to replace suitable light source filter and fluorescent filter, and then controls turning on of the light source by the smart glasses device. In particular, after the exciting light emitted from the light source is filtered by the light source filter, a remaining light of specific wavelength excites the test substance, and the fluorescent light emitted from the excited test substance illuminates upon the front facing camera of the smart glasses device after passing the fluorescent filter. The camera conducts photographing or video recording, and the user may obtain fluorescent information of the test substance from fluorescence images projected on his retina, and thereby proceeds with related processing.

Also, when using the present system for detection, the user may adjust dimensions of photographed fluorescence images by the smart glasses device, and thus the present system may provide accurate detection and operation to substances of various volumes.

Preferably, the light source component further comprises a camera obscura, the light source being installed within the camera obscura, the light source filter wheel being installed on the camera obscura, and the camera obscura being provided with a light transmitting aperture. During operation of the fluorescence photography and camera system, after passing through the light transmitting aperture and the light source filter, the light emitted from the light source illuminates upon the test substance and excites the test substance, and after passing through the fluorescent filter, the fluorescent light emitted from the excited test substance illuminates upon the front facing camera of the smart glasses device.

Preferably, in order to avoid requirement of frequent manual replacements of the light source filters and fluorescent filters while conducting multiple detections, the light source component further comprises a light source motor and a light source motor control module, wherein the light source motor is connected with the smart glasses device by the light source motor control module, and an output shaft of the light source motor is connected with the light source filter wheel; the light source component power supply module supplies power to the light source motor and light source motor control module;

the fluorescent component further comprises a fluorescent motor, a fluorescent motor control module and a fluorescent component power supply module, wherein the fluorescent motor is connected with the smart glasses device by the fluorescent motor control module, and an output shaft of the fluorescent motor is connected with the fluorescent filter wheel; the fluorescent component power supply module supplies power to the fluorescent motor and the fluorescent motor control module; the fluorescent motor is installed on the smart glasses device;

there is a plurality of light source filter apertures, the light source filter being installed on the plurality of light source filter apertures respectively; and there is a plurality of fluorescent filter apertures, the fluorescent filter being installed on the plurality of fluorescent filter apertures respectively.

When conducting multiple detections, the fluorescent motor control module and the light source motor control module may be controlled by the smart glasses device and thereby the fluorescent motor and the light source motor are controlled so as to rotate the light source filter wheel and the fluorescent filter wheel, and thereby replacement of the light source filters and the fluorescent filters is realized.

Preferably, for different light source filter apertures, wavelengths of the light source filters installed thereon are different; and for different fluorescent filter apertures, wavelengths of the fluorescent filters installed thereon are different. On the light source filter wheel and fluorescent filter wheel of the present system, the light source filters and fluorescent filters with different wavelengths are installed respectively, and thus the smart glasses device controls the fluorescent motor control module and the light source motor control module and then controls the fluorescent motor and the light source motor so as to rotate the light source filter wheel and the fluorescent filter wheel, and thereby replacement of different wavelengths of light source filters and fluorescent filters is realized. As a result, the present system is able to conduct detection for a polychromatic light.

Preferably, the light source motor control module comprises a light source motor driving chip, a light source component microcontroller and a light source Bluetooth module; wherein one end of the light source motor driving chip is connected with the light source motor, while the other end is connected with the smart glasses device by the light source component microcontroller and the light source Bluetooth module;

the fluorescent motor control module comprises a fluorescent motor driving chip, a fluorescent component microcontroller and a fluorescent Bluetooth module; wherein one end of the fluorescent motor driving chip is connected with the fluorescent motor, while the other end is connected with the smart glasses device by the fluorescent component microcontroller and the fluorescent Bluetooth module.

Preferably, the fluorescent component power supply module is a bulk battery, the bulk battery and the fluorescent motor control module being installed on the smart glasses device, and the bulk battery being connected with the fluorescent filter wheel by the fluorescent motor control module and the fluorescent motor.

Preferably, there are 5 light source filter apertures, on the 5 light source filter apertures, a shading orifice plate, a blue light filter, an ultraviolet light filter, a red light filter and a green light filter being installed respectively; and there are 5 fluorescent filter apertures, on the 5 fluorescent filter apertures, a bright field filter, a blue light filter, a green light filter, a red light filter and a near-infrared light filter being installed respectively.

Preferably, the fluorescence photography and camera system further comprises an upper computer, the upper computer comprising various intelligent terminals such as a computer, and the upper computer being connected with the smart glasses device. In the process of detecting, the smart glasses device conducts video recording of displayed images, and then transfers the video to the upper computer for backup, after that the upper computer receives the video from the smart glasses device and real-time displays it on a screen.

Preferably, a reflecting condenser is arranged inside the camera obscura, the reflecting condenser condensing and reflecting the exciting light emitted from the light source towards the light transmitting aperture. The arrangement of the reflecting condenser enhances the strength of the exciting light passing through the light transmitting aperture.

Preferably, the light source is a high-voltage mercury lamp, a Xenon and metal halide arc lamp, a laser light, a LED array, or a Tungsten incandescent lamp.

The present invention further provides a control method for the fluorescence photography and camera system based on a smart glasses device, which comprises the following steps: S1. a smart glasses device receives an order, controlling a light source motor and a light source motor by a light source motor control module and a fluorescent motor control module so as to rotate a light source filter wheel and a fluorescent filter wheel, and thereby choose corresponding light source filters and fluorescent filters;

S2. the smart glasses device turns on a light source, after an exciting light emitted from the light source is filtered by the light source filters, a remaining light of specific wavelength excites a test substance, the fluorescent light emitted from the excited test substance illuminates upon the front facing camera of the smart glasses device after passing the fluorescent filters, and the camera conducts photographing or video recording.

Compared with the prior arts, the present invention has the following beneficial effects: the present system conducts photographing of the fluorescence images using the smart glasses device, and then projects the photographed images on the retina of the user; during this procedure, no complicated imaging process is required, and thus the user may real-time acquire the fluorescence images; in the meantime, functions of zoom in and zoom out may be done to the photographed fluorescence images by the smart glasses device, and the users may realize accurate detection and operation of test substances of various volumes; and organic combination of virtual image and real vision may be realized, range of visual sense may be expended, and function of visual sense may be strengthened.

### BRIEF DESCRIPTION OF THE DRAWINGS

FIG. 1 is a schematic view of the fluorescence photography and camera system.

FIG. 2 is a side view of the fluorescence photography and camera system.

FIG. 3 is a detailed schematic view of the fluorescent component.

FIG. 4 is a schematic view of constitution of the light source component.

FIG. 5 is a schematic view of circuit connection of the light source component.

FIG. 6 is a schematic view of circuit connection of the fluorescent component.

### DETAILED DESCRIPTION OF THE PREFERRED EMBODIMENT

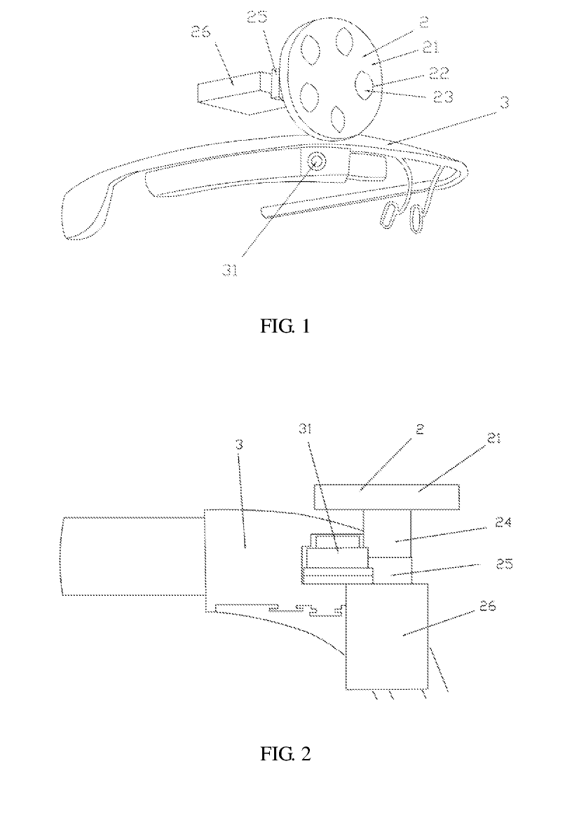

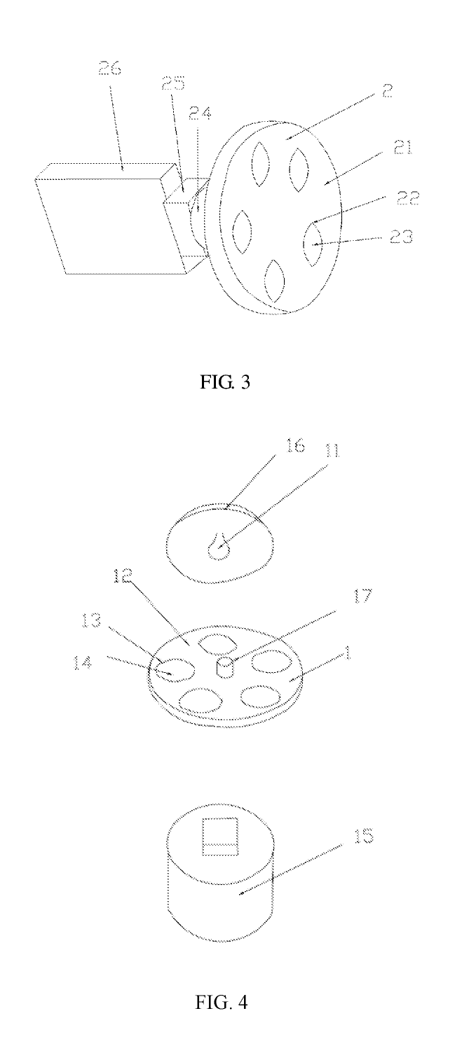

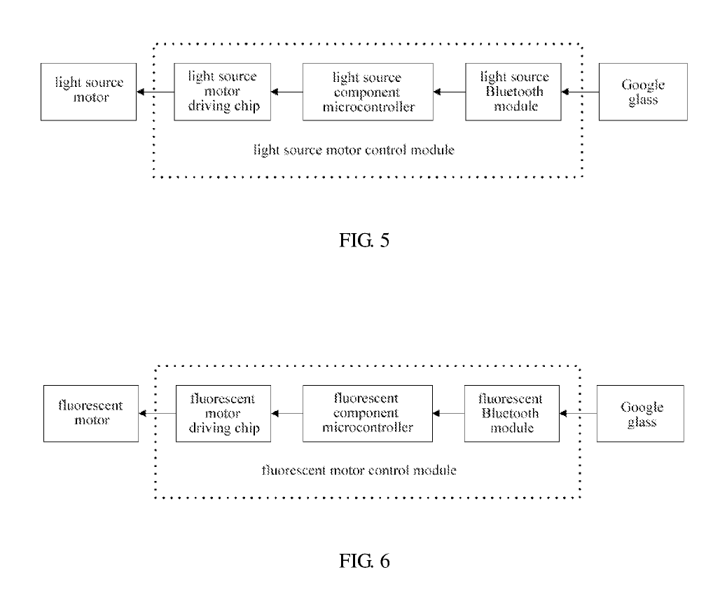

As shown in FIGS. 1, 2, 3, 4, 5 and 6, a fluorescence photography and camera system provided by the present invention comprises a smart glasses device 3, a light source component 1, a fluorescent component 2 and an upper computer, wherein the smart glasses device 3 comprises a front facing camera 31 having no infrared cut-off filter. The smart glasses device 3 may be chosen as Google glass.

In particular, the light source component 1 comprises a light source component power supply module, a camera obscura, a light source 11, and a light source filter wheel 12 that filters a light emitted from the light source 11, the light source 11 being connected with the smart glasses device 3, and the light source component power supply module supplying power to the light source 11; wherein the light source 11 is installed within the camera obscura, and the light source filter wheel 12 is installed on the camera obscura, the camera obscura being provided with a light transmitting aperture, the light source filter wheel 12 being provided with a light source filter aperture 13, and a light source filter 14 being installed on the light source filter aperture 13. In order to enhance the strength of an exciting light passing through the light transmitting aperture, a reflecting condenser 16 is arranged inside the camera obscura, the reflecting condenser 16 condensing and reflecting the exciting light emitted from the light source 11 towards the light transmitting aperture.

In particular, the light source 11 may be a high-voltage mercury lamp, a Xenon and metal halide arc lamp, a laser light, a LED array, or a Tungsten incandescent lamp. In the present embodiment, the light source 11 is a high-voltage mercury lamp.

The fluorescent component 2 comprises a fluorescent filter wheel 21, the fluorescent filter wheel 21 being installed on the smart glasses device 3, the fluorescent filter wheel 21 being provided with a fluorescent filter aperture 22, and a fluorescent filter 23 being installed on the fluorescent filter aperture 22.

During operation of the fluorescence photography and camera system, after passing through the light transmitting aperture and the light source filter 14, a light emitted from the light source 11 illuminates upon a test substance and excites the test substance, and after passing through the fluorescent filters 23, a fluorescent light emitted from the excited test substance illuminates upon the front facing camera 31 of the smart glasses device 3.

In practice, according to different application scenarios, a user may choose the light source filters and fluorescent filters of different wavelengths, and install them on the light source filter aperture and the fluorescent filter aperture respectively.

In the above-described solution, the user wearing the smart glasses device 3, when the fluorescence photography and camera system is required to be turned on to detect the test substance, firstly he/she is required to replace suitable light source filter 14 and fluorescent filter 23, and then controls turning on of the light source 11 by the smart glasses device 3. In particular, after the exciting light emitted from the light source 11 is filtered by the light source filter 14, a remaining light of specific wavelength excites the test substance, the fluorescent light emitted from the excited test substance illuminates upon the front facing camera 31 of the smart glasses device 3 after passing the fluorescent filter 23. The camera 31 conducts photographing or video recording, and the user may obtain fluorescent information of the test substance from fluorescence images projected on his retina, and thereby proceeds with related processing.

The upper computer is connected with the smart glasses device 3. In the process of detecting, the smart glasses device 3 conducts video recording of displayed images, and then transfers the video to the upper computer for backup, after that the upper computer receives the video from the smart glasses device 3 and real-time displays it on a screen.

In the meantime, in the present embodiment, in order to avoid requirement of frequent manual replacements of the light source filters 14 and fluorescent filters 23 while conducting multiple detections, the light source component 1 further comprises a light source motor 15 and a light source motor control module, wherein the light source motor 15 is connected with the smart glasses device 3 by the light source motor control module, and an output shaft of the light source motor 15 is connected with the light source filter wheel 12 by a connection 17. The light source component power supply module supplies power to the light source motor 15 and the light source motor control module. The fluorescent component 2 further comprises a fluorescent motor 24, a fluorescent motor control module 25 and a fluorescent component power supply module 26, wherein the fluorescent motor 24 is connected with the smart glasses device 3 by the fluorescent motor control module 25, and an output shaft of the fluorescent motor 24 is connected with the fluorescent filter wheel 21. The fluorescent component power supply module 26 supplies power to the fluorescent motor 24 and the fluorescent motor control module 25. The fluorescent motor 24 is installed on the smart glasses device 3. The fluorescent component power supply module 26 is a bulk battery, the bulk battery and the fluorescent motor control module 25 being installed on the smart glasses device 3, and the bulk battery being connected with the fluorescent filter wheel 21 by the fluorescent motor control module 25 and the fluorescent motor 24. There is a plurality of light source filter apertures 13, the light source filter 14 being installed on the plurality of light source filter apertures 13 respectively; and there is a plurality of fluorescent filter apertures 22, the fluorescent filter 23 being installed on the plurality of fluorescent filter apertures 22 respectively.

In the above-described solution, when conducting multiple detections, the fluorescent motor control module 25 and the light source motor control module may be controlled by the smart glasses device 3 and thereby the fluorescent motor 24 and the light source motor 15 are controlled so as to rotate the light source filter wheel 12 and the fluorescent filter wheel 21, and thereby replacement of the light source filters 12 and the fluorescent filters 21 is realized.

In particular, for different light source filter apertures 13, wavelengths of the light source filters 14 installed thereon are different; and for different fluorescent filter apertures 22, wavelengths of the fluorescent filters 23 installed thereon are different. On the light source filter wheel 12 and the fluorescent filter wheel 21 of the present system, the light source filters 14 and fluorescent filters 23 with different wavelengths are installed respectively, and thus the smart glasses device 3 controls the fluorescent motor control module 25 and the light source motor control module and then controls the fluorescent motor 24, light source motor 15 so as to rotate the light source filter wheel 12 and the fluorescent filter wheel 21, and thereby replacement of different wavelengths of light source filters 14 and fluorescent filters 23 is realized. As a result, the present system is able to conduct detection for a polychromatic light.

In the present embodiment, there are 5 fluorescent filter apertures 22, on the 5 fluorescent filter apertures 22, a bright field filter, a blue light filter, a green light filter, a red light filter and a near-infrared light filter being installed respectively; and there are 5 light source filter apertures 13, on the 5 light source filter apertures 13, a shading orifice plate, a blue light filter, an ultraviolet light filter, a red light filter and a green light filter being installed respectively.

In the present embodiment, the light source motor control module comprises a light source motor driving chip, a light source component microcontroller and a light source Bluetooth module; wherein one end of the light source motor driving chip is connected with the light source motor 15, while the other end is connected with the smart glasses device 3 by the light source component microcontroller and the light source Bluetooth module. The fluorescent motor control module 25 comprises a fluorescent motor driving chip, a fluorescent component microcontroller and a fluorescent Bluetooth module; wherein one end of the fluorescent motor driving chip is connected with the fluorescent motor 24, while the other end is connected with the smart glasses device 3 by the fluorescent component microcontroller and the fluorescent Bluetooth module.

The present system conducts photographing of fluorescence images using the smart glasses device, and then projects photographed images on a retina of a user. During this procedure, no complicated imaging process is required, and thus the user may real-time acquire the fluorescence images. In the meantime, functions of zoom in and zoom out may be done to the photographed fluorescence images by the smart glasses device, and the users may realize accurate detection and operation of test substances of various volumes. Organic combination of virtual image and real vision may be realized, scope of visual sense may be expended, and function of visual sense may be strengthened.

Apparently, the above-described embodiment of the present invention is just an embodiment for describing the present invention clearly, but not limitation to the implementations of the present invention. For those having ordinary skill in the art, variations or changes in different forms can be made on the basis of the above description. All of the implementations should not and could not be exhaustive herein. Any amendments, equivalent replacements and improvement made within the spirit and principle of the present invention shall all be included within the scope of protection of the claims of the present invention.

1. A fluorescence photography and camera system based on a smart glasses device, comprising, it comprises a light source component, a fluorescent component and a smart glasses device; wherein the smart glasses device comprises a front facing camera having no infrared cut-off filter;
wherein the light source component comprises a light source component power supply module, a light source, and a light source filter wheel that filters a light emitted from the light source, the light source being connected with the smart glasses device, and the light source component power supply module supplying power to the light source; the light source filter wheel is provided with a light source filter aperture, and a light source filter is installed on the light source filter aperture;
the fluorescent component comprises a fluorescent filter wheel, the fluorescent filter wheel being installed on the smart glasses device, the fluorescent filter wheel being provided with a fluorescent filter aperture, and a fluorescent filter being installed on the fluorescent filter aperture;
during operation of the fluorescence photography and camera system, after passing through the light source filter, an exciting light emitted from the light source illuminates upon a test substance and excites the test substance, and a fluorescent light emitted from the excited test substance illuminates upon the front facing camera of the smart glasses device after passing through the fluorescent filter.

2. The fluorescence photography and camera system based on a smart glasses device according to claim 1, wherein the light source component further comprises a camera obscura, the light source being installed within the camera obscura, the light source filter wheel being installed on the camera obscura, and the camera obscura being provided with a light transmitting aperture; during operation of the fluorescence photography and camera system, after passing through the light transmitting aperture and the light source filter, the exciting light emitted from the light source illuminates upon the test substance and excites the test substance, and after passing through the fluorescent filter, the fluorescent light emitted from the excited test substance illuminates upon the front facing camera of the smart glasses device.

3. The fluorescence photography and camera system based on a smart glasses device according to claim 2, wherein the light source component further comprises a light source motor and a light source motor control module, wherein the light source motor is connected with the smart glasses device by the light source motor control module, and an output shaft of the light source motor is connected with the light source filter wheel; the light source component power supply module supplies power to the light source motor and the light source motor control module;
the fluorescent component further comprises a fluorescent motor, a fluorescent motor control module and a fluorescent component power supply module, wherein the fluorescent motor is connected with the smart glasses device by the fluorescent motor control module, and an output shaft of the fluorescent motor is connected with the fluorescent filter wheel; the fluorescent component power supply module supplies power to the fluorescent motor and the fluorescent motor control module; the fluorescent motor is installed on the smart glasses device;
there is a plurality of light source filter apertures, the light source filter being installed on the plurality of light source filter apertures respectively; and there is a plurality of fluorescent filter apertures, the fluorescent filter being installed on the plurality of fluorescent filter apertures respectively.

4. The fluorescence photography and camera system based on a smart glasses device according to claim 3, wherein for different light source filter apertures, wavelengths of the light source filters installed thereon are different; and for different fluorescent filter apertures, wavelengths of the fluorescent filters installed thereon are different.

5. The fluorescence photography and camera system based on a smart glasses device according to claim 3, wherein the light source motor control module comprises a light source motor driving chip, a light source component microcontroller and a light source Bluetooth module; wherein one end of the light source motor driving chip is connected with the light source motor, while the other end is connected with the smart glasses device by the light source component microcontroller and the light source Bluetooth module;
the fluorescent motor control module comprises a fluorescent motor driving chip, a fluorescent component microcontroller and a fluorescent Bluetooth module; wherein one end of the fluorescent motor driving chip is connected with the fluorescent motor, while the other end is connected with the smart glasses device by the fluorescent component microcontroller and the fluorescent Bluetooth module.

6. The fluorescence photography and camera system based on a smart glasses device according to claim 3, wherein the fluorescent component power supply module is a bulk battery, the bulk battery and the fluorescent motor control module being installed on the smart glasses device, and the bulk battery being connected with the fluorescent filter wheel by the fluorescent motor control module and the fluorescent motor.

7. The fluorescence photography and camera system based on a smart glasses device according to claim 6, wherein the fluorescence photography and camera system further comprises an upper computer, the upper computer being connected with the smart glasses device.

8. The fluorescence photography and camera system based on a smart glasses device according to claim 3, wherein a reflecting condenser is arranged inside the camera obscura, the reflecting condenser condensing and reflecting the exciting light emitted from the light source towards the light transmitting aperture.

9. The fluorescence photography and camera system based on a smart glasses device according to claim 6, wherein the light source is a high-voltage mercury lamp, a Xenon and metal halide arc lamp, a laser light, a LED array, or a Tungsten incandescent lamp.

10. A control method for the fluorescence photography and camera system based on a smart glasses device according to claim 3, wherein, it comprises the following steps:
S1. a smart glasses device receives an order, controlling a light source motor and a fluorescent motor by a light source motor control module and a fluorescent motor control module so as to rotate a light source filter wheel and a fluorescent filter wheel, and thereby choose corresponding light source filters and fluorescent filters;
S2. the smart glasses device turns on a light source, after passing through the light source filters, an exciting light emitted from the light source excites a test substance, a fluorescent light emitted from the excited test substance illuminates upon a front facing camera of the smart glasses device after passing the fluorescent filters, and the camera conducts photographing or video recording.
